(19) United States
(12) Patent Application Publication
(10) Pub. No.: US 2026/0277026 A1
(43) Pub. Date: Sep. 17, 2026

(54) Heatable Photochromic Laminate and Method of Making the Same

(71) Applicant: Transitions Optical, Ltd., Tuam (IE)

(72) Inventors: Brian Smyth, Tuam (IE); David J. Park, Tuam (IE)

(21) Appl. No.: 19/162,213

(22) PCT Filed: Mar. 7, 2023
(86) PCT No.: PCT/EP2023/055653

§ 371 Date: Sep. 4, 2025

(51) Int. Cl. G02C 7/10; G02B 1/04; G02B 1/14; G02C 7/02

(52) U.S. Cl. CPC G02C 7/102; G02B 1/041; G02B 1/14; G02C 7/02; G02B 2207/101; G02C 2202/16

(57) ABSTRACT

A heatable optical laminate is provided. The heatable optical laminate includes: a first optical element, the first optical element includes: a first polymeric film layer including a first surface and a second surface, and an electrode located over at least a portion of the first surface, wherein the electrode includes an electrically conductive three-dimensional network; a second optical element, the second optical element including: a second polymeric film layer including a first surface and a second surface, and a photochromic adhesive layer including at least one photochromic material and at least one adhesive over at least a portion of the first surface; and a power supply electrically connected to the electrode of the first optical element. The electrode of the first optical element is adhered to at least a portion of the photochromic adhesive layer of the second optical element. A method of making the heatable optical laminate is also provided.

### BACKGROUND OF THE INVENTION

### Field of the Invention

The present invention relates to heatable optical laminates and a method of making heatable optical laminates. In particular, the present invention relates to heatable optical laminates having a first optical element comprising a first polymeric film layer comprising a first surface and a second surface opposite the first surface, and an electrode located over at least a portion of the first surface, the electrode having an electrically conductive three-dimensional network; a second optical element comprising a second polymeric film layer comprising a first surface and a second surface opposite the first surface and a photochromic adhesive layer comprising at least one photochromic material and at least one adhesive over at least a portion of the first surface; and a power supply electrically connected to the electrode of the first element, wherein the electrode of the first optical element is adhered to at least a portion of the photochromic adhesive layer of the second optical element.

### Description of Related Art

In response to certain wavelengths of electromagnetic radiation (e.g., actinic radiation), photochromic compounds typically undergo a transformation from one form or state to another state or form, with each form having a characteristic or distinguishable absorption spectrum associated therewith. Typically, upon exposure to actinic radiation, many photochromic compounds transform from a closed-form, which corresponds to an unactivated (or bleached) state (e.g., substantially colorless) to an open-form, which corresponds to an activated (or colored) state. When the actinic radiation is removed, the photochromic compounds may reversibly transform from the activated or colored state back to the unactivated or bleached state. A “thermally reversible photochromic compound” is a photochromic compound that converts from an unactivated or bleached state to an activated or colored state in response to actinic radiation, and reverts back to the unactivated or bleached state in response to thermal energy.

Compositions and articles, such as eyewear lenses, that contain photochromic materials or have photochromic materials applied thereto, such as in the form of a photochromic laminate, typically display colorless and colored states that correspond to the colorless and colored states of the photochromic materials contained therein and/or applied thereto.

However, the fade speed from the activated or colored state to the unactivated or colorless state can depend upon the ambient temperature. For example, the switching time of the photochromic material from the activated or colored state to the unactivated or colorless state in cold temperatures can be slow. It would be desirable to develop an optical laminate that could heat photochromic materials within the optical laminate to improve the fade speed of the photochromic materials.

### SUMMARY OF THE INVENTION

In some non-limiting examples or aspects of the present disclosure, provided is a heatable optical laminate. The optical laminate includes: a first optical element, the first optical element including: a first polymeric film layer including a first surface and a second surface opposite the first surface, and an electrode located over at least a portion of the first surface, wherein the electrode includes an electrically conductive three-dimensional network; a second optical element, the second optical element including: a second polymeric film layer including a first surface and a second surface opposite the first surface, and a photochromic adhesive layer including at least one photochromic material and at least one adhesive over at least a portion of the first surface; and a power supply electrically connected to the electrode of the first element. The electrode of the first optical element is adhered to at least a portion of the photochromic adhesive layer of the second optical element.

In some non-limiting examples or aspects of the present disclosure, provided is a method of making a heatable optical laminate. The method includes: providing a first optical element, wherein the first optical element includes: an electrode over at least a portion of a first surface of a first polymeric film layer, wherein the electrode includes: an electrically conductive three-dimensional network of an electrically conductive material; forming a second optical element, wherein forming the second optical element includes: applying a photochromic adhesive composition including at least one photochromic material and at least one thermoplastic adhesive over at least a portion of a first surface of a second polymeric film layer; positioning the electrode of the first optical element to be in contact with the photochromic adhesive composition of the second optical element; laminating the first optical element and the second optical element; and connecting a power supply to the electrode of the first element.

A heatable optical laminate and a method of making a heatable optical laminate may be characterized by one or more of the following aspects.

In a first aspect, a heatable optical laminate, includes: a first optical element, the first optical element including: a first polymeric film layer comprising a first surface and a second surface opposite the first surface, and an electrode located over at least a portion of the first surface, wherein the electrode includes an electrically conductive three-dimensional network; a second optical element, the second optical element including: a second polymeric film layer comprising a first surface and a second surface opposite the first surface, and a photochromic adhesive layer including at least one photochromic material and at least one adhesive over at least a portion of the first surface; and a power supply electrically connected to the electrode of the first element, wherein the electrode of the first optical element is adhered to at least a portion of the photochromic adhesive layer of the second optical element.

In a second aspect, in the heatable optical laminate in accordance with the first aspect, further including one or more bus bars or electrical leads in electrical contact with the electrode, wherein the one or more bus bars or electrical leads are electrically connected to the power supply.

In a third aspect, in the heatable optical laminate in accordance with the first aspect or the second aspect, the electrically conductive three-dimensional network includes an electrically conductive material comprising conductive nanowires.

In a fourth aspect, in the heatable optical laminate in accordance with the third aspect, the conductive nanowires comprise silver nanowires, nickel nanowires, copper nanowires, carbon nanotube coated silver nanowires, or combinations of two or more thereof.

In a fifth aspect, in the heatable optical laminate in accordance with the fourth aspect, the conductive nanowires include silver nanowires.

In a sixth aspect, in the heatable optical laminate in accordance with any one of the first aspect to the fifth aspect, the electrode further includes an electrically conductive encapsulating layer adjacent to the electrically conductive three-dimensional network.

In a seventh aspect, in the heatable optical laminate in accordance with the sixth aspect, the electrically conductive encapsulating layer includes an electrically conductive encapsulating material comprising a conductive polymer, a doped metal oxide, and/or carbon nanotubes.

In an eighth aspect, in the heatable optical laminate in accordance with the seventh aspect, the conductive polymer includes poly(3,4-ethylenedioxythiophene) polystyrene sulfonate (PEDOT:PSS).

In a ninth aspect, in the heatable optical laminate in accordance with the seventh aspect, the electrically conductive encapsulating material includes a doped metal oxide selected from aluminum doped zinc oxide or indium doped tin oxide.

In a tenth aspect, in the optical laminate in accordance with any one of the first aspect to the ninth aspect, the at least one adhesive includes a thermoplastic polyurethane, an acrylic block copolymer, or combinations thereof.

In an eleventh aspect, in the optical laminate in accordance with any one of the first aspect to the tenth aspect, the electrode is between the first polymeric film layer and the photochromic adhesive layer.

In a twelfth aspect, in the optical laminate in accordance with any one of the first aspect to the eleventh aspect, the electrode has a sheet resistance of less than 60 Ohms per square (Ω/□) and the first optical element has a visible light transmittance of at least 80%.

In a thirteenth aspect, in the optical laminate in accordance with any one of the first aspect to the twelfth aspect, the optical laminate has a visible light transmittance of at least 75%.

In a fourteenth aspect, in the optical laminate in accordance with any one of the first aspect to the thirteenth aspect, the first polymeric film layer and/or the second polymeric film layer include a polymeric material comprising polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl(meth)acrylate, polyvinyl butyral, polystyrene, copolymers of two or more thereof, or mixtures of two or more thereof.

In a fifteenth aspect, a method of making a heatable optical laminate includes: providing a first optical element, wherein the first optical element includes: an electrode over at least a portion of a first surface of a first polymeric film layer, wherein the electrode includes an electrically conductive three-dimensional network of an electrically conductive material; forming a second optical element, wherein forming the second optical element includes: applying a photochromic adhesive composition including at least one photochromic material and at least one adhesive over at least a portion of a first surface of a second polymeric film layer; positioning the electrode of the first optical element to be in contact with the photochromic adhesive composition of the second optical element; laminating the first optical element and the second optical element; and connecting a power supply to the electrode of the first element.

In a sixteenth aspect, in the method of making a heatable optical laminate in accordance with the fifteenth aspect, the electrically conductive three-dimensional network is formed by applying a dispersion of the electrically conductive material, wherein the electrically conductive material includes conductive nanowires.

In a seventeenth aspect, in the method of making a heatable optical laminate in accordance with the sixteenth aspect, the conductive nanowires comprise silver nanowires, nickel nanowires, copper nanowires, carbon nanotube coated silver nanowires, or combinations of two or more thereof.

In an eighteenth aspect, in the method of making a heatable optical laminate in accordance with the seventeenth aspect, the conductive nanowires include silver nanowires.

In a nineteenth aspect, in the method of making a heatable optical laminate in accordance with the sixteenth aspect, optionally further including sintering the electrically conductive material to form the electrically conductive three-dimensional network.

In a twentieth aspect, in the method of making a heatable optical laminate in accordance with the nineteenth aspect, the electrically conductive material is sintered using electromagnetic radiation.

In a twenty-first aspect, in the method of making a heatable optical laminate in accordance with any one of the fifteenth aspect to the twentieth aspect, further including: applying an electrically conductive encapsulating material adjacent to the electrically conductive three-dimensional network to form an electrically conductive encapsulating layer.

In a twenty-second aspect, in the method of making a heatable optical laminate in accordance with the twenty-first aspect, the electrically conductive encapsulating material comprises a conductive polymer, a doped metal oxide, and/or carbon nanotubes.

In a twenty-third aspect, in the method of making a heatable optical laminate in accordance with the twenty-second aspect, the conductive polymer includes poly(3,4-ethylenedioxythiophene) polystyrene sulfonate (PEDOT:PSS).

In a twenty-fourth aspect, in the method of making a heatable optical laminate in accordance with any one of the fifteenth aspect to the twenty-third aspect, the at least one adhesive includes a thermoplastic polyurethane, an acrylic block copolymer, or combinations thereof.

In a twenty-fifth aspect, in the method of making a heatable optical laminate in accordance with any one of the fifteenth aspect to the twenty-fourth aspect, optionally further including heating the optical laminate after laminating.

In a twenty-sixth aspect, an optical article includes the heatable optical laminate in accordance with any one of the first aspect to the fourteenth aspect.

In a twenty-seventh aspect, in the optical article in accordance with the twenty-sixth aspect, the article is an optical element selected from the group consisting of ophthalmic articles, display articles, windows, and mirrors, preferably the ophthalmic article is selected from the group consisting of corrective lenses, non-corrective lenses, contact lenses, and protective lenses.

### BRIEF DESCRIPTION OF THE DRAWINGS

FIG. 1A is a side view (not to scale) of a heatable optical laminate in accordance with some examples of the present disclosure;

FIGS. 2A and 2B are side views (not to scale) of electrodes in accordance with some examples of the present disclosure;

FIGS. 3A-3C are side views (not to scale) of heatable optical laminates in accordance with some examples of the present disclosure;

FIG. 4 is a side view (not to scale) of an optical article in accordance with an example of the present disclosure; and

FIGS. 5A-5C are side views (not to scale) of optical articles in accordance with an example of the present disclosure.

### DESCRIPTION OF THE INVENTION

As used herein, the singular form of “a”, “an”, and “the” include plural referents unless the context clearly dictates otherwise.

Spatial or directional terms, such as “left”, “right”, “inner”, “outer”, “above”, “below”, and the like, relate to the invention as shown in the drawing figures and are not to be considered as limiting as the invention can assume various alternative orientations.

Other than in the operating examples, or where otherwise indicated, all numbers expressing quantities of ingredients, reaction conditions, and so forth used in the specification and claims are to be understood as modified in all instances by the term “about”. By “about” is meant plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, or C” includes A alone; or B alone; or C alone; or A and B; or A and C; or B and C; or all of A, B, and C.

As used herein, the term “polymer” means homopolymers (e.g., prepared from a single monomer species), copolymers (e.g., prepared from at least two monomer species), and graft polymers.

As used herein, the term “(meth)acrylate” and similar terms, such as “(meth)acrylic acid ester” means derivatives of acrylic acid and methacrylic acid, inclusive of acrylate esters, methacrylate esters, acrylamides, methacrylamides, acrylic acid and methacrylic acid. As used herein, the term “(meth)acrylic acid” means methacrylic acid and/or acrylic acid.

The term “adjacent” means proximate to and optionally, in direct contact with.

The term “includes” is synonymous with “comprises”.

The term “optical” means pertaining to or associated with light and/or vision. For example, an optical element, article, or device can be chosen from ophthalmic elements, articles, and devices; display elements, articles, and devices; visors; windows; and mirrors.

Non-limiting examples of display devices include augmented reality (AR) and virtual reality (VR) devices.

The term “ophthalmic” means pertaining to or associated with the eye and vision. Non-limiting examples of ophthalmic articles or elements include corrective and non-corrective lenses, including single vision or multi-vision lenses, which may be either segmented or non-segmented multi-vision lenses (such as, but not limited to, bifocal lenses, trifocal lenses, and progressive lenses), as well as other elements used to correct, protect, or enhance (cosmetically or otherwise) vision, including without limitation, contact lenses, intra-ocular lenses, magnifying lenses, and protective lenses or visors.

As used herein, the terms “lens” and “lenses” mean and encompass at least individual lenses, lens pairs, partially formed (or semi-finished) lenses, fully formed (or finished) lenses, and lens blanks.

As used herein, the term “transparent”, such as used in connection with a substrate, film, material, and/or coating, means that the indicated substrate, film, material, and/or coating has the property of transmitting visible light without appreciable scattering so that objects lying beyond are visibly observable.

As used herein, the term “actinic radiation” means electromagnetic radiation that is capable of causing a response in a material, such as, but not limited to, transforming a photochromic material from one form or state to another as will be discussed in further detail herein.

As used herein, the terms “ultraviolet”, “UV”, “ultraviolet light”, or “ultraviolet radiation” mean electromagnetic radiation having a wavelength in the range of 10 nm to 400 nm.

As used herein, the term “coating” means a supported film derived from a flowable coating material, which can optionally have a uniform thickness. The terms “layer” encompasses coatings (such as a coating layer), films and sheets, and a layer can include a combination of separate layers, including sub-layers and/or over-layers. The verb “coating” means, within appropriate context, the process of applying a coating material (or materials) to the substrate to form a coating (or coating layer).

As used herein, the term “dispersion” means a suspension of particles (e.g., conductive nanowires) in water and/or an organic solvent.

As used herein, the terms “sinter” or “sintering” means the application of heat or light to cause a change in a layer or a material. The change may comprise melting of an organic material (e.g., polymers), burning off of an organic material (e.g., polymers), or welding together metallic nanomaterials (e.g., nanowires).

As used herein, the terms “formed over”, “deposited over”, “provided over”, “applied over”, “residing over”, or “positioned over” mean formed, deposited, provided, applied, residing, or positioned on but not necessarily in direct (or abutting) contact with the underlying element, or surface of the underlying element. For example, a layer “positioned over” a substrate does not preclude the presence of one or more other layers, coatings, or films of the same or different composition located between the positioned or formed layer and the substrate.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

The term “alkyl” as used herein, means linear or branched C₁-C₂₅ alkyl. Linear or branched alkyl can include C₁-C₂₅ alkyl, such as C₁-C₂₀ alkyl, such as C₂-C₁₀ alkyl, such as C₁-C₁₂ alkyl, such as C₁-C₆ alkyl.

The invention comprises, consists of, or consists essentially of the following examples of the invention, in any combination. Various examples of the invention may be discussed separately. However, it is to be understood that this is simply for ease of illustration and discussion. In the practice of the invention, one or more aspects of the invention described in one example can be combined with one or more aspects of the invention described in one or more of the other examples.

The invention described herein is directed to a heatable optical laminate 10. As used herein “heatable” means capable of being heated upon the addition of electrical energy. The heatable optical laminate 10 comprises: a first optical element 12 comprising a first polymeric film layer 14 comprising a first surface 16 and a second surface 18 opposite the first surface 16, and an electrode 20 located over at least a portion of the first surface 16, wherein the electrode 20 comprises an electrically conductive three-dimensional network 22; a second optical element 26 comprising a second polymeric film layer 28 comprising a first surface 30 and a second surface 32 opposite the first surface 30 and a photochromic adhesive layer 34 comprising at least one photochromic material and at least one adhesive over at least a portion of the first surface 30; and a power supply 36 electrically connected to the electrode 20 of the first optical element 12. The electrode 20 of the first optical element 12 is adhered to at least a portion of the photochromic adhesive layer 34 of the second optical element 26.

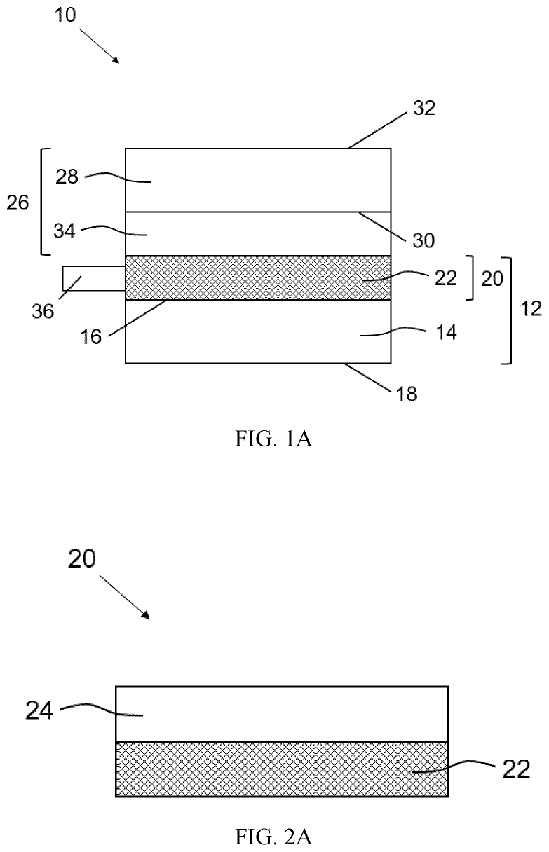

With reference to FIG. 1A, the heatable optical laminate 10 comprises a first optical element 12 comprising a first polymeric film layer 14. The first polymeric film layer 14 comprises a first surface 16 and a second surface 18 opposite the first surface 16. The first polymeric film layer 14 can be of any desired material having any desired characteristics. In general, the first polymeric film layer 14 can be made of various materials including, but not limited to, organic materials, inorganic materials, or combinations thereof (for example, composite materials).

The first polymer film layer 14 can comprise a polymeric film comprised of any of a wide variety of film materials, including thermoset and thermoplastic materials, such as are well known in the optical industry. Specific, non-limiting examples of organic materials that may be used for the first polymeric film layer 14 disclosed herein include polymeric materials selected from the group consisting of polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl(meth)acrylate, polyvinyl butyral, polystyrene copolymers thereof, and mixtures thereof. Especially useful are polycarbonates, such as Bisphenol A-based polycarbonates, due to their compatibility with insert injection molding techniques, their high transparency, impact resistance, and high refractive index.

A non-limiting example of an inorganic material suitable for the first polymeric film layer 14 includes glass.

The first polymeric film layer 14 can be untinted, tinted, linearly polarizing, circularly polarizing, elliptically polarizing, and/or photochromic polymeric film layers. As used herein, with reference to polymeric film layers, the term “untinted” means polymeric film layers that are essentially free of coloring agent additions (such as, but not limited to, conventional dyes) and have an absorption spectrum for visible radiation that does not vary significantly in response to actinic radiation. Further, with reference to polymeric film layers, the term “tinted” means optical substrates that have a coloring agent addition (such as, but not limited to, conventional dyes) and an absorption spectrum for visible radiation that does not vary significantly in response to actinic radiation. As used herein, the term “linearly polarizing” with reference to polymeric film layers refers to polymeric film layers that are adapted to linearly polarize radiation (i.e., confine the vibrations of the electric vector of light waves to one direction). As used herein, the term “circularly polarizing” with reference to polymeric film layers refers to polymeric film layers that are adapted to circularly polarize radiation. As used herein, the term “elliptically polarizing” with reference to polymeric film layers refers to optical substrates that are adapted to elliptically polarize radiation.

The first optical element 12 of the heatable optical laminate 10 further comprises an electrode 20 located over at least a portion of the first surface 16 of the first polymeric film layer 14. The electrode 20 comprises an electrically conductive three-dimensional network 22. As used herein, “an electrically conductive three-dimensional network” means a three-dimensional unstructured array of an electrically conductive material that has a continuous electrical pathway when contacted with electrical energy.

The electrically conductive three-dimensional network 22 comprises an electrically conductive material. Suitable electrically conductive materials for the electrically conductive three-dimensional network can include, but are not limited to conductive nanowires. The conductive nanowires may be selected from silver nanowires, nickel nanowires, copper nanowires, carbon nanotube coated silver nanowires, and combinations of two or more thereof. The nanowires, e.g., silver nanowires, may optionally be coated with a polymer, such as polyvinylpyrolidone.

For example, the electrically conductive material of the electrically conductive three-dimensional network 22 may be silver nanowires. The silver nanowires may have a length of from 1 micron (μm) to 100 μm, such as from 5 μm to 60 μm, or such as from 10 μm to 30 μm.

For example, the silver nanowires may have a diameter of from 10 nanometers (nm) to 150 nm, such as from 10 nm to 100 nm, such as from 10 nm to 80 nm, or such as from 10 nm to 60 nm.

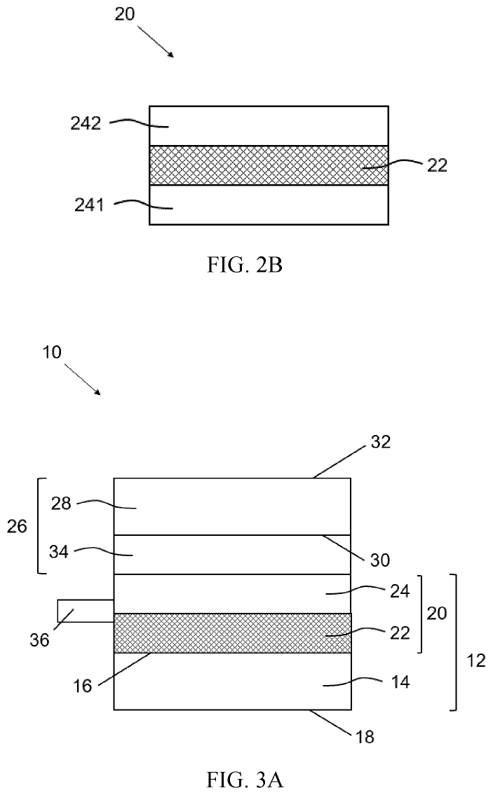

The electrode 20 may further comprise an electrically conductive encapsulating layer 24 that is positioned adjacent to and in direct contact with the electrically conductive three-dimensional network 22, as provided in FIG. 2A. The electrically conductive encapsulating layer 24 comprises an electrically conductive encapsulating material. Suitable electrically conductive encapsulating materials can include, but are not limited to conductive polymers, doped metal oxides, carbon nanotubes, and combinations thereof. The electrically conductive encapsulating material of the electrically conductive encapsulating layer 24 may comprise a conductive polymer comprising poly(3,4-ethylenedioxythiophene) polystyrene sulfonate (PEDOT:PSS). The PEDOT:PSS may be optionally doped with dimethyl sulfoxide (DMSO) or methanol. The electrically conductive encapsulating material of the electrically conductive encapsulating layer 24 may comprise a doped metal oxide including, but not limited to aluminum doped zinc oxide or indium doped tin oxide. The electrically conductive encapsulating material of the electrically conductive encapsulating layer 24 may comprise carbon nanotubes. The carbon nanotubes may be applied with a polymeric binder, such as a polyester polymer, an acrylic binder, and/or a polyurethane binder.

The electrically conductive encapsulating layer 24 may be positioned over the electrically conductive three-dimensional network 22 to form the electrode 20, as provided in FIG. 2A. Alternatively, the electrically conductive three-dimensional network 22 may be positioned between a first electrically conductive encapsulating layer 241 and a second electrically conductive encapsulating layer 242, as provided in FIG. 2B.

The electrode 20 of the heatable optical laminate 10 comprises a sheet resistance of less than 60 Ohms per square (Ω/□). For example, the sheet resistance of the electrode 20 of the heatable optical laminate 10 may be less than 40Ω/□, or less than 30Ω/□. The sheet resistance may range from 5Ω/□ to 60Ω/□ such as from 5Ω/□ to 50Ω/□, from 5Ω/□ to 40Ω/□, from 5Ω/□ to 30Ω/□, or from 5Ω/□ to 20Ω/□ Sheet resistance may be measured by a four-point probe.

The first optical element 12 may have a visible light transmittance of at least 80% as measured by a spectrophotometer, such as an UltraScan Pro (HunterLab). The visible light transmittance of the first optical element 12 may be at least 80% or at least 85%, as measured by a spectrophotometer, such as an UltraScan Pro (photopic).

The first optical element 12 may have a haze value of less than 5%, such as less than 3%, or such as less than 2%, when measured using a haze-gard plus (BYK-Gardner) according to ASTM D1003 (method B).

With continued to reference to FIG. 1A, the heatable optical laminate 10 comprises a second optical element 26 comprising a second polymeric film layer 28. The second polymeric film layer 28 comprises a first surface 30 and a second surface 32 opposite the first surface 30. The second polymeric film layer 28 can be of any desired material having any desired characteristics. The second polymeric film layer 28 may be any of the materials as described herein with respect to the first polymeric film layer 14, including, but not limited to, organic materials, inorganic materials, or combinations thereof (for example, composite materials). The second polymeric film layer 28 may be the same as the first polymeric film layer 14. Alternatively, the second polymeric film layer 28 may be different from the first polymeric film layer 14. Optionally, the second polymeric film layer 28 may comprise an ordered polymeric film, such as those know in the art to be formed by extrusion or stretching.

The first polymeric film layer 14 and/or the second polymeric film layer 28 each independently may further comprise any of a wide variety of additives to influence or enhance one or more of the processing and/or performance properties of the layer. Non-limiting examples of such additives can include dyes, photoinitiators, thermal initiators, polymerization inhibitors, solvents, light stabilizers (such as, but not limited to, ultraviolet light absorbers and light stabilizers, such as hindered amine light stabilizers (HALS)), heat stabilizers, mold release agents, rheology control agents, leveling agents (such as, but not limited to, surfactants), free radical scavengers, and adhesion promoters.

The first polymeric film layer 14 and/or the second polymeric film layer 28 each independently may be comprised of a single layer (or ply) of any one of the abovementioned materials; or each of the first polymeric film layer 14 and/or the second polymeric film layer 28 each independently may be comprised of multiple layers of one of the abovementioned materials; or the first polymeric film layer 14 and/or the second polymeric film layer 28 each independently may be comprised of multiple layers of different materials such as any of those previously mentioned. The thicknesses of first polymeric film layer 14 and the second polymeric film layer 28 are independent of one another and can widely vary depending upon the type of material(s) comprising the polymeric film layer(s) and the desired end use thereof.

Generally, the first polymeric film layer 14 and/or the second polymeric film layer 28 each independently can have a thickness ranging from 25 μm to 2000 μm, such as from 100 μm to 1000 μm, or from 100 μm to 500 μm. The thickness of each of the first polymeric film layer 14 and the second polymeric film layer 28 can range independently between any of the above-stated values, inclusive of the stated values.

The second optical element 26 of the heatable optical laminate 10 further comprises a photochromic adhesive layer 34 comprising at least one photochromic material and at least one adhesive located over at least a portion of the first surface 30 of the second polymeric film layer 28.

As used herein, the term “photochromic material” includes thermally reversible photochromic compounds.

As used herein, to modify the term “state”, the terms “first” and “second” are not intended to refer to any particular order or chronology, but instead refer to two different conditions or properties. For purposes of non-limiting illustration, the first state and the second state of a photochromic material can differ with respect to at least one optical property, such as but not limited to the absorption of visible and/or UV radiation. Thus, the photochromic materials of the present invention can have a different absorption spectrum in each of the first and second state. For example, while not limiting herein, a photochromic material of the present invention can be clear in the first state and colored in the second state. Alternatively, a photochromic material of the present invention can have a first color in the first state and a second color in the second state.

Generally, although not limiting herein, when two or more photochromic materials are used in conjunction with each other, the various materials can be chosen to complement one another to produce a desired color or hue. For example, mixtures of photochromic materials can be used, as disclosed herein, to attain certain activated colors, such as, a near neutral gray or near neutral brown. See, for example, U.S. Pat. No. 5,645,767, column 12, line 66 to column 13, line 19, the disclosure of which is specifically incorporated by reference herein, which describes the parameters that define neutral gray and brown colors.

The photochromic material can comprise any of a variety of organic and inorganic photochromic materials. The photochromic material(s) can include but is not limited to, the following classes of materials: chromenes, e.g., naphthopyrans, benzopyrans, indeno fused naphthopyrans, phenanthropyrans or mixtures thereof; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides and mixtures of such photochromic compounds.

The photochromic material of the photochromic adhesive layer 34 may be a photochromic-dichroic material. As used herein the term “photochromic-dichroic materials” refers to materials that display photochromic properties and dichroic properties in response to at least actinic radiation. As used herein, the term “dichroic” means capable of absorbing one of two orthogonal plane polarized components of at least transmitted radiation more strongly than the other. For example, a photochromic-dichroic material can be adapted to reversibly transform from a first optically clear (colorless), non-polarizing state in at least the visible spectrum to a second colored, polarizing state in at least the visibly spectrum in response to at least actinic radiation. Non-limiting examples of photochromic-dichroic materials include the photochromic-dichroic materials described in U.S. Patent Application Publication No. 2005/0004361, at paragraph 27 to paragraph 158, the disclosure of which is incorporated herein by reference.

The photochromic adhesive layer 34 further comprises at least one adhesive. Suitable adhesives include, but are not limited to a thermoplastic polyurethane, an acrylic block copolymer, and combinations thereof. The acrylic block copolymer may be a solvent-cast triblock polymer, such as a solvent-cast triblock polymer comprising polymethyl methacrylate (PMMA) and poly(butyl acrylate) (PBA). Suitable solvents include esters, non-limiting examples of which include ethyl acetate, butyl acetate and isopropyl acetate, or ethers such as tetrahydrofuran. The photochromic material may be present in the photochromic adhesive layer 34 in an amount from about 0.5 percent to about 10 percent by weight, or from about 1 percent to about 8 percent by weight, or from about 2 percent to about 5 percent by weight, based on the weight of the adhesive.

The photochromic adhesive layer may have a thickness in a range from 15 μm to 100 μm, such as from 30 μm to 70 μm, or from 40 μm to 60 μm.

The electrode 20 the first optical element 12 is adhered to at least a portion of the photochromic adhesive layer 34 of the second optical element 26, as provided in FIG. 1A. For example, the electrode 20 is between the first polymeric film layer 14 and the photochromic adhesive layer 34. The photochromic adhesive layer 34 may be positioned over the electrically conductive three-dimensional network 22 of the electrode, as provided in FIG. 1A. Alternatively, the electrically conductive three-dimensional network 22 of the electrode 20 may be positioned over the photochromic adhesive layer 34.

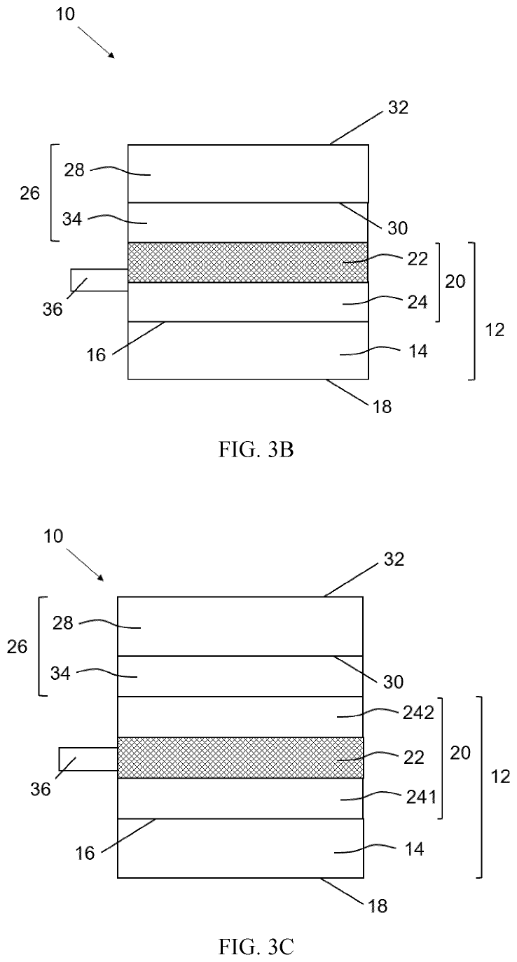

Alternatively, when the electrode 20 comprises a first electrically conductive encapsulating layer 241 and a second electrically conductive encapsulating layer 242, the first electrically conductive encapsulating layer 241 may be positioned over at least a portion of the first surface 14 of the optical substrate 12 and the photochromic adhesive layer 34 may be positioned over the second electrically conductive encapsulating layer 242, as provided in FIG. 3C.

The heatable optical laminate 10 comprises a power supply 36 that is electrically connected to the electrode 20. The power supply 36 may be any suitable power supply, such as a direct current battery, a solar power cell, an alternating current power supply, or combinations thereof. For example, the power supply 36 may be a lithium-ion battery or an alkaline battery. The power supply 36 may be electrically connected to the edge of the electrode 20. For example, the power supply 36 may be electrically connected to the edge of the electrically conductive three-dimensional network 22 and/or the edge of the electrically conductive encapsulating layer 24. Alternatively, the power supply 36 may be electrically connected to one or more bus bars that are in electrical contact with the electrode 20. The power supply 36 applies a voltage to the electrode 20. The power supply 36 may apply from 0.5 Volts (V) to 15 V, such as from 1 V to 10 V, such as from 1 V to 5 V, or such as from 1.5 V to 4 V. Based on the size and the sheet resistance of the electrode 20 of the heatable optical laminate 10, a current is generated from the voltage that is applied by the power supply 36 to heat the optical laminate. The current generated depends upon the voltage applied by the power supply 36, the size of the electrode 20, the relative distance between the one or more bus bars (if present), and the sheet resistance of the electrode 20. For example, for an ophthalmic lens-sized heatable optical article 100 that includes the heatable optical laminate 10 of the present invention, the power supply 36 would be selected within the described voltage ranges to deliver a current of from 0.2 ampere (amp) to 0.8 amp. One having ordinary skill in the art would recognize that the dimensions of the heatable optical article 100 that includes the heatable optical laminate 10 will determine the total resistance and current, as well as the number of bus bars needed (if using), required to heat the optical article 100.

The voltage of the power supply 36 may be selected in order to raise the temperature of the heatable optical laminate 10 by at least 2° C., such as by at least 5° C. or such by at least 10° C. The voltage of the power supply 36 may be selected in order to heat the heatable optical laminate 10 to a temperature of at least 20° C., at least 25° C., at least 27° C., at least 30° C., at least 35° C., or at least 37° C. The voltage of the power supply 36 may be selected in order to heat the heatable optical laminate 10 to a temperature in the range of from at least 20° C. to at least 37° C., such as at least 20° C. to at least 35° C., such as from at least 20° C. to at least 25° C., such as from at least 25° C. to at least 30° C., such as from at least 20° C. to at least 30° C., or such as from at least 25° C. to at least 37° C. The voltage may be applied from the power supply 36 continuously or pulsed for specified time, such as for at least 20 seconds, at least 30 seconds, at least 40 seconds, at least 50 seconds, at least 60 seconds, or greater than 60 seconds to achieve the desired fade rate.

The heatable optical laminate 10 may comprise one or more bus bars and/or electrical leads that are in electrical contact with the electrode 20 and the one or more bus bars and/or electrical leads are electrically connected to the power supply 36. The bus bars have a lower resistivity compared to the electrode 20 and are intended to distribute the electrical current from the power supply 36 evenly over the electrode 20 to heat the optical laminate 10. The bus bars may be made of any suitable material, such as a metallic foil strip, deposited metallic layers, or combinations thereof. For example, the heatable optical laminate 10 may include two or more bus bars positioned on at least one surface of the electrode 20 along opposite sides, and the power supply 36 is connected to the two or more bus bars. Alternatively, the bus bars may be printed onto at least one surface of the electrode 20 with a conductive ink, such as a colloidal silver epoxy ink. The bus bars may be configured as parallel strips on opposite sides of the electrode 20 and connected to the power supply 36. Alternatively, electrical leads may be attached to each bus bar and extend away from the opposite edges of the optical laminate 10 and be connected to the power supply 36.

The heatable optical laminates 10 of the present invention may have a visible light transmittance of at least 75%, at least 80%, or such as at least 85% when the photochromic material of the photochromic adhesive layer 34 is in the unactivated or colorless state.

The heatable optical laminate 10 of the present invention may have a haze value of less than 6%, such as less than 4%, or such as less than 2.5%, when measured using a haze-gard plus (BYK-Gardner) according to ASTM D1003 (method B).

The present invention is also directed to a method of making a heatable optical laminate 10. The method comprises: providing a first optical element 12; forming a second optical element 26; positioning the electrode 20 of the first optical element 12 to be in contact with the photochromic adhesive composition of the second optical element 26; laminating the first optical element 12 and the second optical element 26; and connecting a power supply 36 to the electrode 20 of the first optical element 12. The first optical element 12 comprises an electrode 20 over at least a portion of a first surface 16 of a first polymeric film layer 14, wherein the electrode 20 comprises an electrically conductive three-dimensional network 22 of an electrically conductive material. Forming the second optical element 26 comprises applying a photochromic adhesive composition comprising at least one photochromic material and at least one adhesive over at least a portion of a first surface 30 of a second polymeric film layer 28.

The electrically conductive three-dimensional network 22 of the electrode 20 may be formed by applying a dispersion comprising the electrically conductive material. The dispersion comprising the electrically conductive material may be a dispersion having an electrically conductive material and a dispersion medium. The dispersion medium can include, but is not limited to, water, anisole, methanol, isopropyl alcohol, ethanol, or combinations thereof. The electrically conductive material may be present in the dispersion in an amount from 0.05 to 5 percent by weight. The dispersion comprising the electrically conductive material may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the dispersion comprising the electrically conductive material according to the present invention), and combinations thereof.

The electrically conductive material may be optionally sintered to form the electrically conductive three-dimensional network 22.

The electrically conductive material may be sintered using electromagnetic radiation, such as UV radiation having a wavelength of from 300 nanometers to 450 nanometers, to form the electrically conductive three-dimensional network 22. For example, the source of the electromagnetic radiation may be a solar lamp, a mercury lamp, a mercury lamp doped with FeI₃ or GaI₃, a germicidal lamp, a light emitting diode, a xenon lamp, a tungsten lamp, a metal halide lamp, or a combination of such lamps. The exposure time of the electrically conductive material to the electromagnetic radiation source will vary depending upon the wavelength and intensity of the electromagnetic radiation source. The electrically conductive material is exposed to the electromagnetic radiation source for a sufficient time to cause local heating of the electrically conductive material (e.g., conductive nanowires) to increase the conductivity (e.g., decrease the resistance) within the three-dimensional network 22. For example, when the electromagnetic source is source that emits only UV radiation, the electrically conductive material may be exposed to the electromagnetic radiation source for 10 seconds to 3 minutes. When the source is a solar lamp, the electrically conductive material may be exposed for 30 seconds to 1 hour.

The method may further comprise applying an electrically conductive encapsulating material adjacent to and in direct contact with the electrically conductive three-dimensional network 22 to form an electrically conductive encapsulating layer 24.

The electrically conductive three-dimensional network 22 may optionally be etched prior to the application of the electrically conductive encapsulating material, such as by plasma, by chemical etching with ferric nitrate, or other means, in order to increase the adhesion of the electrically conductive encapsulating material to the electrically conductive three-dimensional network 22.

When the electrically conductive encapsulating material comprises a conductive polymer as described herein, the electrically conductive encapsulating layer 24 may be formed by applying an electrically conductive encapsulating material solution, wherein the electrically conductive encapsulating material solution comprises the conductive polymer and one or more solvents. The solvents may include, but are not limited to, water, anisole, methanol, isopropyl alcohol, ethanol, dimethyl sulfoxide (DMSO), and combinations thereof. For example, the electrically conductive encapsulating material solution may comprise water and the conductive polymer in an amount ranging from at least 0.25 weight % to at least 5 weight %, or such as from at least 0.5 weight % to at least 3 weight %, based on the total weight of the electrically conductive encapsulating material solution. The electrically conductive encapsulating material solution comprising the conductive polymer may be applied in accordance with art-recognized methods including, but not limited to: spray application methods, curtain coating application methods, draw-down blade (or bar) application methods, dip-coating application methods, spin-coating application methods, jet printing methods (such as inkjet printing methods, where the “ink” is replaced with the electrically conductive encapsulating material solution according to the present invention), and combinations thereof.

When the electrically conductive encapsulating material comprises a doped metal oxide as described herein, the electrically conductive encapsulating material may be applied by any suitable method, including but not limited to, those methods listed above, chemical vapor deposition (CVD), magnetron sputtering vapor deposition (MSVD), plasma vapor deposition, spray pyrolysis, and combinations thereof.

When the electrically conductive encapsulating material comprises carbon nanotubes as described herein, the electrically conductive encapsulating layer 24 may be formed by applying an electrically conductive encapsulating solution, wherein the electrically conductive encapsulating solution comprises the carbon nanotubes, an optional polymeric binder, and a solvent. The solvent may include, but is not limited to, water. The optional polymer binder may be a polyester polymer or a polyurethane binder.

After the application of the electrically conductive encapsulating material, the first optical element 12 may be thermally treated. The thermal treatment of the first optical element 12 may evaporate any solvents and/or coalesce any polymeric materials. For example, the first optical element 12 may be thermally treated 1 minute, 2 minutes, 5 minutes, 10 minutes, 20 minutes, 30 minutes, 40 minutes, 50 minutes, or 60 minutes at a temperature ranging from 30° C. to 150° C.

The photochromic adhesive composition comprising at least one photochromic material and at least one adhesive may be applied over at least a portion of the first surface 30 of the second polymeric film layer 28 in accordance with art-recognized methods including, but not limited to: spray application methods, curtain coating application methods, draw-down blade (or bar) application methods, dip-coating application methods, spin-coating application methods, extrusion methods, jet printing methods (such as inkjet printing methods, where the “ink” is replaced with the photochromic coating composition according to the present invention), and combinations thereof.

The photochromic adhesive composition comprising at least one photochromic material and at least one adhesive can be applied to (i.e., cast onto or coated onto) the second polymeric film layer 28, optionally thermally treated, and then laminated to the electrode 20 of the first optical element 12. Alternatively, the photochromic adhesive composition first can be cast onto a release liner (for example by slot-die, knife-over-roll, reverse-roll, or gravure application methods) and then, optionally, thermally treated. The heatable optical laminate 10 can then be prepared by transfer-lamination methods which involves removal of the release liner and lamination of the photochromic adhesive layer 34 to the second polymeric film layer 28, and to the electrode 20 of the first optical element 12 using known lamination methods.

After the electrode 20 of the first optical element 12 is positioned to be in contact with the photochromic adhesive composition of the second optical element 26, the first optical element 12 and the second optical element 26 are laminated. For example, the first optical element 12 and the second optical element 26 may be laminated, such as by hot roller lamination, at a temperature ranging from 80° C. to 130° C., such as from 90° C. to 120° C., and under a pressure of at least 1 bar.

The optical laminate 10 may be optionally heated after laminating. The optical laminate 10 may be heated in an oven after laminating. For example, the optical laminate 10 may heated in an oven at 120° C. for at least 1 hour after laminating.

The lamination and optional heating step converts the photochromic adhesive composition to the photochromic adhesive layer 34. After laminating and optionally heating, the electrode 20 may be between the first polymeric film layer 12 and the photochromic adhesive layer 34.

An optical article 100 may comprise the heatable optical laminate 10 described herein. The optical article may be an optical element 102 selected from the group consisting of ophthalmic articles, display articles, windows, and mirrors. The heatable optical laminates 10 are especially useful for ophthalmic articles selected from the group consisting of corrective lenses, non-corrective lenses, contact lenses, and protective lenses. Preparation of visors, face-shields, intraocular lenses, and magnifying lenses also is contemplated.

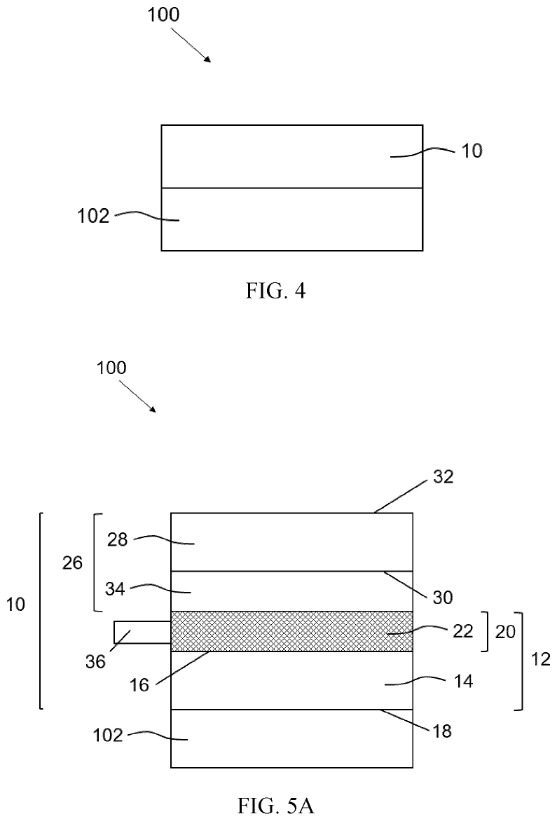

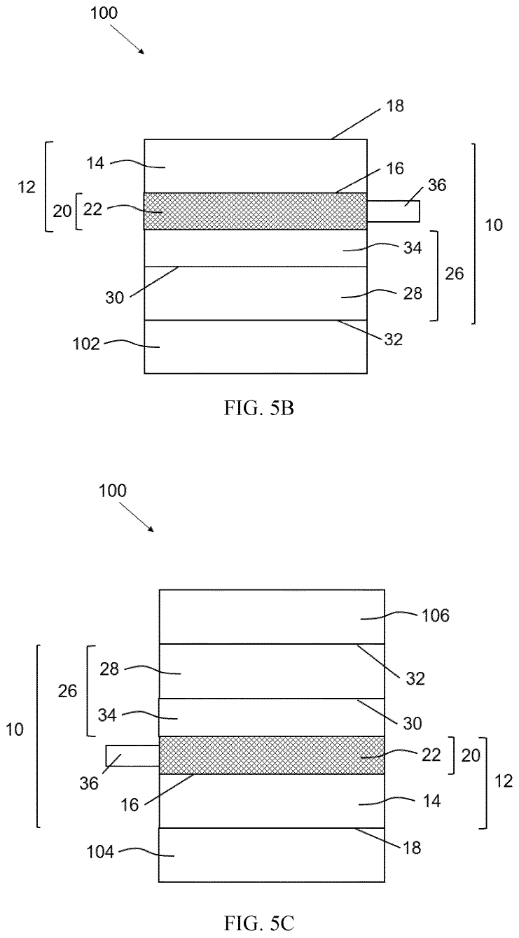

The heatable optical laminate 10 may be positioned over at least a portion of the optical element 102 to form the optical article 100, as provided in FIG. 4. For example, the second surface 18 of the first polymeric film layer 14 of the heatable optical laminate 10 may be positioned over at least a portion of the optical element 102 to form the optical article 100, as provided in FIG. 5A. Alternatively, the second surface 32 of the second polymeric film layer 28 of the heatable optical laminate 10 may be positioned over at least a portion of the optical element 102 to form the optical article 100, as provided in FIG. 5B. The heatable optical laminate 10 may be positioned over at least a portion of a first optical element 104 and a second optical element 106 may be positioned over at least a portion of the heatable optical laminate 10 to form the optical article 100, as provided in FIG. 5C. The heatable optical laminate 10 may be attached to the surface of the optical element 102 using a pressure sensitive adhesive. As used herein, “pressure-sensitive adhesive” is a type of non-reactive adhesive that forms a bond when pressure is applied. Alternatively, the optical laminate 10 may be cast-in place in order to form the optical article 100. For example, the heatable optical laminate 10 may be cut to size and placed in a mold. The mold may then be filled with a curable polymer. The curable polymer may then be cured such that the heatable optical laminate 10 is encased within the cured polymer to form the optical article 100. Alternatively, the heatable optical laminate 10 may be thermoformed and then applied onto a curved optical element 102. Alternatively, the heatable optical laminate 10 may be thermoformed and then applied into a curved optical element 102. For example, the heatable optical laminate 10 may be thermoformed and then positioned over at least a portion of a curved first optical element 104 and a curved second optical element 106 may be positioned over at least a portion of the heatable optical laminate 10 to form the optical article 100.

The present invention is described in the following illustrative, non-limiting examples. Numerous possible modifications and variations will be apparent to those skilled in the art.

### Examples

### Materials and Methods

Optical Element with Photochromic Adhesive

A photochromic adhesive was prepared by combining the components in Table 1, and mixing on a roller mixing unit for 18 hours after which time all ingredients had fully dissolved.

TABLE 1
Photochromic adhesive formulation

| | Parts |
|---|---|
| Component | by weight |
| Photochromic dye blend¹ | 16 |
| TINUVIN ® 144² | 50 |
| Tetrahydrofuran | 7211 |
| Ethyl Acetate | 1002 |
| TECOFLEX ™ SG-80³ | 1626 |
| Poly(maleic anhydride-alt-1-octadecene) | 43 |

¹A blend of photochromic indenofused naphthopyran dyes.
²A hindered amine light stabilizer and antioxidant available from BASF.
³A thermoplastic polyurethane available from The Lubrizol Corporation.

Following this, a portion of the photochromic adhesive solution was deposited on a 50 μm silicone release liner using a Coatema S2S laboratory doctor blade coater. The wet coating was applied at a 500 μm thickness and the coating samples were then thermally treated in a Batch Thermal Oven under the temperature schedule shown in Table 2.

TABLE 2
Thermal treatment of photochromic adhesive

| | | | |
|---|---|---|---|
| 5 | mins | 50° | C. |
| 5 | mins | 55° | C. |
| 15 | mins | 90° | C. |
| 45 | mins | 120° | C. |

The photochromic adhesive was then transferred from the Release liner to a 300 μm polycarbonate film (PURE-ACE® 3000, available from Teijin Resins). The transfer was accomplished using a pressurized roller lamination unit at a speed of 0.75 inches per second (in/sec) and a pressure of 200 kilopascals (kPa). The polycarbonate film with the photochromic adhesive was again thermally treated using the conditions in Table 2.

Optical Element with Electrode

Silver nanowires were applied to a 175 μm sheet of polycarbonate. The nanowire layer was 30 nm in thickness. To this was applied single walled carbon nanotube doped acrylic. The material is commercially available as AgeNT™-10 from CHASM™. Bus bars (7 millimeters (mm) wide) were printed using Dysol®DYAG50 conductive silver ink (available from MilliPore Sigma).

The optical and electrical properties of this film were checked in advance of lamination, as provided in Table 3 below.

TABLE 3
Properties of polymeric film with electrode

| Metric | Device | Result |
|---|---|---|
| Haze | BYK Haze-gard Plus | 1.2 |
| % Transmittance | Hunterlab Ultrascan | 84% |
| | Pro | |
| Sheet resistance | Ossila 4 point Probe | 8 Ohms/ |
| | T2001A3 | sq (Ω/□) |

### Optical Laminate

The layer with photochromic adhesive was laminated to the layer with the electrode, positioned such that the photochromic adhesive and the electrode were in contact with one another. The lamination was completed using a pressurized roller system at a speed of 0.75 in/sec at a pressure of 2 bar.

After lamination, the assembly was heated to 80° C. to avoid any bubbling of residual moisture. Additional samples were first vacuum drying 20 hours under 1.8 bar at 55° C., followed by a thermal treatment at 120° C. for 60 mins. Laminates were then cut to approximately 38 mm×60 mm, including the 7 mm bus bars on the long edges.

### Results

### Optical Properties

Initially, the optical properties were recorded of the full laminate in the bleached state, as provided in Table 4 below.

TABLE 4
Properties of laminate

| Metric | Device | Measurement |
|---|---|---|
| Haze | BYK Hazgard Plus S/ | 1.8% |
| | No. 111139 | |
| % Transmittance | Hunterlab Ultrascan | 80.2% |
| (BL Y) | Pro | |

### Temperature Elevation Testing

Table 5 below gives the parameters and associated settings used for electrically activating the conductive layers of the laminate. Temperatures were measured by a Fluke PTi120 Thermal imaging camera.

TABLE 5
Parameters and associated settings for activating
the conductive layers of the laminate

| | | |
|---|---|---|
| Voltage applied | 3.7 | V |
| Voltage time | 60 | seconds |
| Measured Current | 0.47 | amp |
| Temperature recorded | 37° | C. |
| at end of voltage | | |
| application | | |

| | |
|---|---|
| Electrical Power | RS Pro RS3005D |
| Source | |

Additional laminates with the same dimensions and arrangement of bus bars as the Example above were prepared with varying sheet resistances to demonstrate the relationship between applied voltage and temperature rise as shown in Table 6 below.

TABLE 6
Additional laminates with varying sheet resistances

| Sheet | | Measured | Temperature after | Increase in |
|---|---|---|---|---|
| resistance | Voltage | current | 60 seconds | temperature |
| (Ω/□) | applied (V) | (Amps) | (Ambient 20° C.) | (° C.) |
| 5 | 3.7 | 0.74 | 42.2 | 22.2 |
| 8 | 3.7 | 0.46 | 37.2 | 17.2 |
| 10 | 3.7 | 0.37 | 35.5 | 15.5 |
| 5 | 1.75 | 0.35 | 33.2 | 13.2 |
| 8 | 1.75 | 0.21 | 28.6 | 8.6 |
| 10 | 1.75 | 0.17 | 24.5 | 4.5 |

### Photochromic Performance

The photochromic performance was tested on an Oriel Apex illuminator which used a Halogen Light Source HL-2000-FHSA. The test conditions can be found in Table 7.

TABLE 7
Test conditions for photochromic performance

| | | |
|---|---|---|
| Ambient Temperature | 23° | C. |
| Activation Time | 300 | seconds |

| | |
|---|---|
| Activation Irradiance | 7.7 Watts per |
| | cubic meter |
| | (W/m³) |

Response measurements, in terms of a change in optical density (ΔOD) from the unactivated or bleached state to the activated or colored state were determined by establishing the initial unactivated transmittance, % Tb. Change in optical density was determined according to the formula: ΔOD=log(10)(% Tb/% Ta), where % Tb is the percent transmittance in the bleached (unactivated) state, % Ta is the percent transmittance in the activated state. Delta Optical density measurements were based on photopic optical density.

The % Ta and ΔOD at saturation was recorded after 15 minutes of activation at 23° C. The Fade Half-life (“T½”) value is the time interval in seconds for the ΔOD of the activated form of the photochromic material in the coating to reach one half the ΔOD recorded after 15 minutes of activation at 23° C. described above, after removal of the activating light source. Time to 70% transmittance (“TT 70%”) was determined by recording the fade of the lens to 70% photopic % T in seconds after removal of the activation light source at the end of 15 minutes of activation at 23° C.

Photochromic testing was carried out without electrical power to the laminate and then with electrical power to understand the effect of the increase in temperature on the fade rate of the photochromics. In the case of the power on test, voltage was applied to the laminate at the exact moment the photochromic activation stimulus was removed (UV Light irradiance). The voltage applied was 3.7 V and was supplied for this test by RS Pro RS3005D (S/No. 175-7376). Table 8 below tracks the activation and fade curves of both tests and clearly shows an enhanced photochromic fade when the voltage is applied to the laminate.

TABLE 8
Activation and Fade Results

| | | | | | 1^{st} | TT | |
|---|---|---|---|---|---|---|---|
| | Temperature | % | % | | T_{1/2} | 70% | Haze |
| Voltage | (° C.) | Tb | Ta | ΔOD | (sec) | (sec) | (%) |
| None | 23° C. | 80.1 | 14 | 0.758 | 52 | 160 | 1.7 |
| 3.7 V | 37.2° C. @ | 80.1 | 14 | 0.758 | 19 | 62 | 1.7 |
| | 60 seconds | | | | | | |

As shown in Table 8 above, application of voltage to the article and the temperature elevation that this produced resulted in significantly faster fade, as shown by lower T½ and Time to 70% values.

The present invention has been described with reference to specific details of particular embodiments thereof. It is not intended that such details be regarded as limitations upon the scope of the invention except insofar as and to the extent that they are included in the accompanying claims.

1. A heatable optical laminate, comprising:
a first optical element, the first optical element comprising:
a first polymeric film layer comprising a first surface and a second surface opposite the first surface, and
an electrode located over at least a portion of the first surface, wherein the electrode comprises an electrically conductive three-dimensional network;
a second optical element, the second optical element comprising:
a second polymeric film layer comprising a first surface and a second surface opposite the first surface, and
a photochromic adhesive layer comprising at least one photochromic material and at least one adhesive over at least a portion of the first surface; and
a power supply electrically connected to the electrode of the first optical element,
wherein the electrode of the first optical element is adhered to at least a portion of the photochromic adhesive layer of the second optical element.

2. The optical laminate of claim 1, further comprising one or more bus bars or electrical leads in electrical contact with the electrode, wherein the one or more bus bars or electrical leads are electrically connected to the power supply.

3. The optical laminate of claim 1, wherein the electrically conductive three-dimensional network comprises an electrically conductive material comprising conductive nanowires.

4. The optical laminate of claim 3, wherein the conductive nanowires comprise silver nanowires, nickel nanowires, copper nanowires, or combinations of two or more thereof.

5. The optical laminate of claim 1, wherein the electrode further comprises an electrically conductive encapsulating layer adjacent to the electrically conductive three-dimensional network.

6. The optical laminate of claim 5, wherein the electrically conductive encapsulating layer comprises an electrically conductive encapsulating material comprising a conductive polymer, a doped metal oxide, and/or carbon nanotubes.

7. The optical laminate of claim 6, wherein the conductive polymer comprises poly(3,4-ethylenedioxythiophene) polystyrene sulfonate (PEDOT:PSS).

8. The optical laminate of claim 6, wherein the electrically conductive encapsulating material comprises a doped metal oxide selected from aluminum doped zinc oxide or indium doped tin oxide.

9. The optical laminate of claim 1, wherein the at least one adhesive comprises a thermoplastic polyurethane, an acrylic block copolymer, or combinations thereof.

10. The optical laminate of claim 1, wherein the electrode is between the first polymeric film layer and the photochromic adhesive layer.

11. The optical laminate of claim 1, wherein the electrode has a sheet resistance of less than 60 Ohms per square (Ω/□) and the first optical element has a visible light transmittance of at least 80%.

12. The optical laminate of claim 1, wherein the optical laminate has a visible light transmittance of at least 75%.

13. The optical laminate of claim 1, wherein the first polymeric film layer and/or the second polymeric film layer comprise a polymeric material comprising polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, polyether, polyamide, polyalkyl(meth)acrylate, polyvinyl butyral, polystyrene, copolymers of two or more thereof, or mixtures of two or more thereof.

14. A method of making a heatable optical laminate, the method comprising:
providing a first optical element, wherein the first optical element comprises:
an electrode over at least a portion of a first surface of a first polymeric film layer, wherein the electrode comprises an electrically conductive three-dimensional network of an electrically conductive material,
forming a second optical element, wherein forming the second optical element comprises:
applying a photochromic adhesive composition comprising at least one photochromic material and at least one adhesive over at least a portion of a first surface of a second polymeric film layer;
positioning the electrode of the first optical element to be in contact with the photochromic adhesive composition of the second optical element;
laminating the first optical element and the second optical element; and
connecting a power supply to the electrode of the first element.

15. The method of claim 14, wherein the electrically conductive three-dimensional network is formed by applying a dispersion of the electrically conductive material,
wherein the electrically conductive material comprises conductive nanowires.

16. The method of claim 15, wherein the conductive nanowires comprise silver nanowires, nickel nanowires, copper nanowires, carbon nanotube coated silver nanowires, or combinations of two or more thereof.

17. The method of claim 15, optionally further comprising sintering the electrically conductive material to form the electrically conductive three-dimensional network.

18. The method of claim 17, wherein the electrically conductive material is sintered using electromagnetic radiation.

19. The method of claim 1, further comprising:
applying an electrically conductive encapsulating material adjacent to the electrically conductive three-dimensional network to form an electrically conductive encapsulating layer.

20. The method of claim 19, wherein the electrically conductive encapsulating material comprises a conductive polymer, a doped metal oxide, and/or carbon nanotubes.

21. The method of claim 14, wherein the at least one adhesive comprises a thermoplastic polyurethane, an acrylic block copolymer, or combinations thereof.

22. The method of claim 14, optionally further comprising heating the optical laminate after laminating.

23. An optical article comprising the optical laminate of claim 1.

24. The optical article of claim 23, wherein the article is an optical element selected from the group consisting of ophthalmic articles, display articles, windows, and mirrors, preferably the ophthalmic article is selected from the group consisting of corrective lenses, non-corrective lenses, contact lenses, and protective lenses.
